(19) United States
(12) Patent Application Publication
(10) Pub. No.: US 2003/0048290 A1
(43) Pub. Date: Mar. 13, 2003

(54) Automated marketing system and process

(76) Inventors: David Scott Leone, Drexel Hill, PA (US); Dariusz Paul Gluchowski, Philadelphia, PA (US); Stephen Eric Anderson, Upper Darby, PA (US); David Adam Dever, Drexel Hill, PA (US)

Correspondence Address: GEORGE A LEONE, SR, 2150 128TH AVENUE, NW, MINNEAPOLIS, MN, 55448, US

(21) Appl. No.: 10/196,315

(22) Filed: Jul. 16, 2002

Related U.S. Application Data
(60) Provisional application No. 60/305,640, filed on Jul. 16, 2001.

(51) Int. Cl. G09G 5/00

(52) U.S. Cl. 345/731; 345/764

(57) ABSTRACT

An automated marketing system for facilitate marketing of products and services comprising a graphical user interface (GUI) that accesses a computer program, the computer program and GUI access a plurality of lower level program modules, wherein the lower level program modules include at least one dynamic layout with hot areas, at least one electronic sheet, and at least one electronic vignette, and wherein the lower level program modules include computer algorithms.

### CROSS REFERENCE TO RELATED APPLICATIONS

This application is a conversion of Provisional Application Serial No. 60/305640 of Leone et al. filed Jul. 16, 2001 entitled AUTOMATED MARKETING PROCESS.

### FIELD OF THE INVENTION

The present invention relates to the field of automated marketing software.

### BACKGROUND OF THE INVENTION

CD-ROM tools and other computer-based products are used for high impact training of personnel for many consumer products. A drawback of current CD-ROM tools is that, until now, such tools have not effectively integrated dynamic layouts with hot areas, a plurality of electronic sheets, and a plurality of electronic vignettes.

### SUMMARY OF THE INVENTION

Automated Marketing Process to facilitate marketing of products and services comprising a graphical user interface (GUI) that accesses a computer program. The computer program and GUI access a plurality of sub-programs, a plurality of dynamic layouts with hot areas, a plurality of electronic sheets, and a plurality of electronic vignettes.

The sub-programs comprise algorithms that access and control the operation of the marketing software. The dynamic layouts comprise graphical images and sounds that change with or without user input or change with input from the sub-programs. The electronic sheets comprise images, sounds and numbers that change with or without user input or change with input from the sub-programs. Additionally, the electronic sheets may also contain mathematical equations and algorithms for completing complex calculations with or without user input or with input from the sub-programs. The electronic vignettes comprise graphical images and sounds that change with or without user input or change with input from the sub-programs.

### BRIEF DESCRIPTION OF THE DRAWINGS

FIG. 1 schematically illustrates a software flowchart that embodies an example of the present invention.

FIG. 2 schematically illustrates an example of a marketing software graphical user interface constructed in accordance with the principles of the present invention.

FIG. 3 schematically illustrates an example of a marketing software graphical user interface with a survey system constructed in accordance with the principles of the present invention.

FIG. 4 schematically illustrates an example embodiment of a dynamic layout with hot areas constructed in accordance with the principles of the present invention.

FIG. 5 schematically illustrates an example of an electronic marketing worksheets constructed in accordance with the principles of the present invention.

FIG. 6 schematically illustrates an example of an electronic marketing display sheet constructed in accordance with the principles of the present invention.

FIG. 7 illustrates an electronic survey as contemplated by one example embodiment of the present invention.

FIG. 8 schematically illustrates electronic vignettes as contemplated by one example embodiment of the present invention.

FIG. 9 shows an example of hardware used to implement one embodiment of the present invention.

### DESCRIPTION OF THE PREFERRED EMBODIMENTS

The system and process of the invention is described herein with reference to certain examples. It will be understood that the examples used are by way of illustration and that the invention is not so limited.

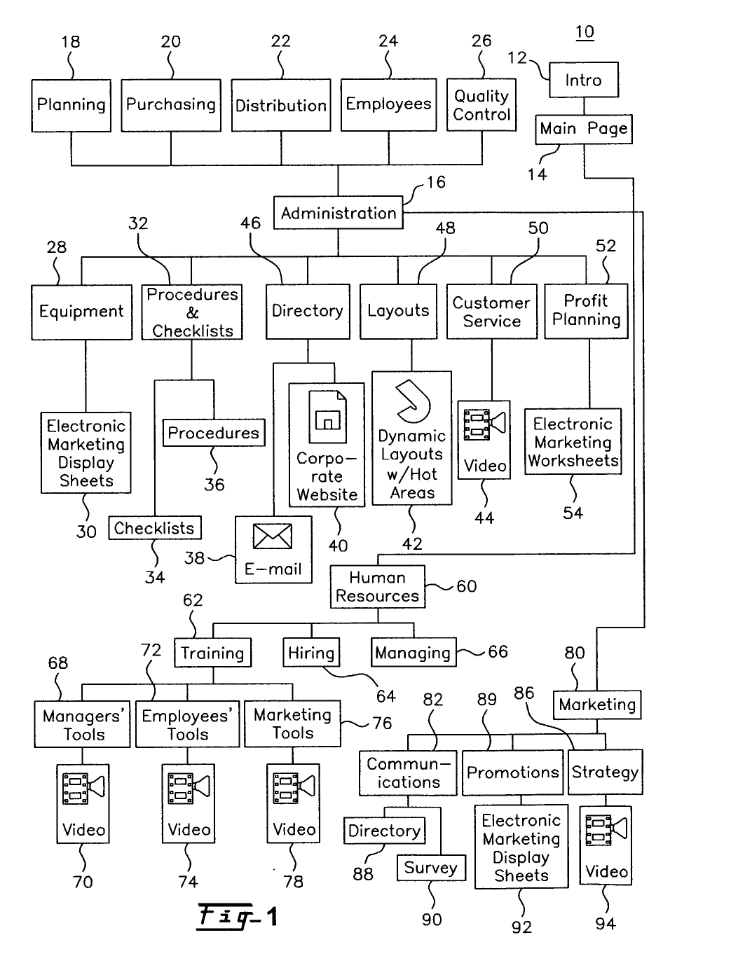

Referring now to FIG. 1, there shown is a software flowchart that embodies an example of the marketing process of the present invention. The marketing process 10 includes an introduction routine 12 linked to a main page 14. The marketing process 10 preferably resides on a computer such as a personal computer or laptop, a server, or a computer network. The main page 14 is linked in turn to a plurality of sub-programs including, for example, an administration program 16, a human resources program 60 and a marketing program 80. Each program, also called modules herein, may generate a page for display such as, for example, a graphical user interface, a web page, a display sheet, a survey form, a dynamic layout with hot areas and/or a combination of any or all of the listed pages or other known display pages. Those skilled in the art having the benefit of this disclosure will understand that each module includes information, instructions, videos, audio or the like related to its subject title.

The administration page 16 may also advantageously be linked to a further plurality of administration modules representing, processing or linking to, for example, computer routines, hyperlink addresses, and computer sites, such as websites and databases. The plurality of administration modules include a planning module 18, a purchasing module 20, a distribution module 22, an employee module 24, a quality control module 26, an equipment module 28, a procedures and checklists module 32, a directory 46, at least one layout 48, a customer service module 50 and a profit planning module 52.

The equipment module 28 may further be advantageously linked to at least one first electronic marketing display sheet 30. The procedures and checklists module 32 may be advantageously linked to at least one lower level module such as at least one checklist 34 and at least one procedure document or page 36. The directory 46 may be advantageously linked to at least one lower level module including, for example, at least one e-mail address 38, and at least one corporate website site 40. The at least one layout 48 may be advantageously linked to at least one lower level module including, for example, at least one dynamic layout area with hot areas 42. The customer service module 50 may be advantageously linked to at least one lower level module including, for example, at least one video module 44. The profit planning module 52 may also be linked to at least one profit planning electronic marketing worksheet 54.

Similarly, the human resources page 60 may also advantageously be linked to a further plurality of human resources page modules representing, processing or linking to, for example, computer routines, hyperlink addresses, and computer sites, such as websites and databases. The plurality of human resources page modules may advantageously include a training module 62, a hiring module 64 and a managing module 66. The training module 62 may further include a plurality of lower level modules including manager's tools 68, employee's tools 72 and marketing tools 76. Each or any of the lower level training modules may include or be otherwise linked to at least one video 70, 74 and 78 respectively.

Similarly, the marketing page 80 may also advantageously be linked to a further plurality of marketing modules representing, processing or linking to, for example, computer routines, hyperlink addresses, and computer sites, such as websites and databases. The plurality of marketing modules may advantageously include a communications module 82, a promotions module 89 and a strategy module 86. The communications module 82 may further be advantageously linked to a communications directory 88 and a survey 90. The promotions module 89 may further be advantageously linked to at least one electronic marketing display sheet. The strategy module 86 may further be advantageously linked to at least one strategy video 94.

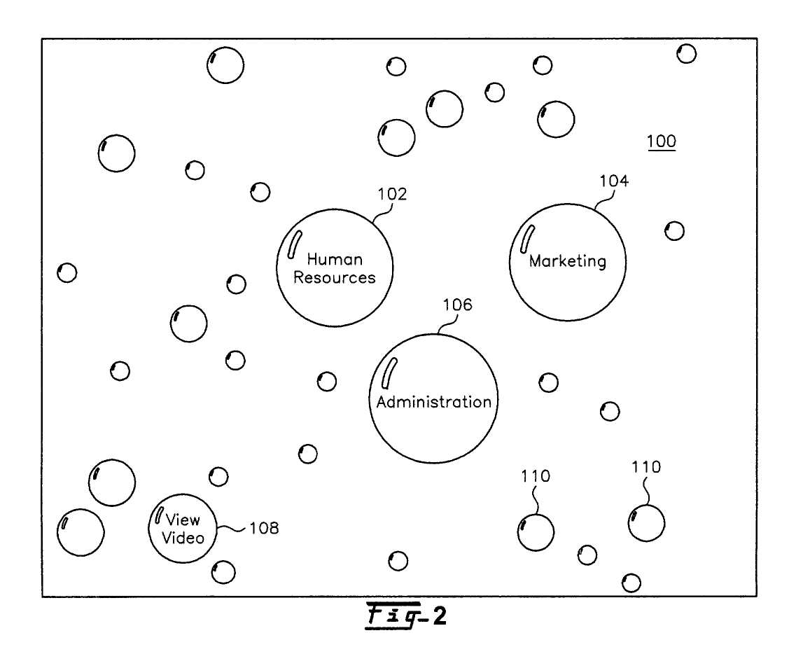

Referring now to FIG. 2, there shown is an example of a marketing software graphical user interface. The example of a marketing software graphical user interface 100 includes a plurality of hot areas including human resources 102, marketing 104, administration 106 and view video 108. A hot area, or more commonly hot spot, is a predefined area in the user interface (ui) that, when the user's cursor enters as, for example, under control of a computer mouse point-and-click device, leaves (mouse out), clicks that area by depressing a mouse button or releases a mouse button, a code event or other event is triggered, controlled, or otherwise activated. The most common type of hot spot is a button icon or hyperlink to an Internet location or other site, usually residing on a computer server or the like.

For example, when a user clicks the human resources hot area 102, the user will enter the human resources module 60 where a human resources page will be displayed to the user, enabling access to the other human resources modules.

When a user clicks the marketing hot area 104, the user will enter the marketing module 80 where a marketing page will be displayed to the user, enabling access to the other marketing modules.

When a user clicks the administration hot area 106, the user will enter the marketing module 80 where an administration page will be displayed to the user, enabling access to the other administration modules. Clicking the view video hot area 108 links the user to a video page where a prerecorded, digitized video will play on command.

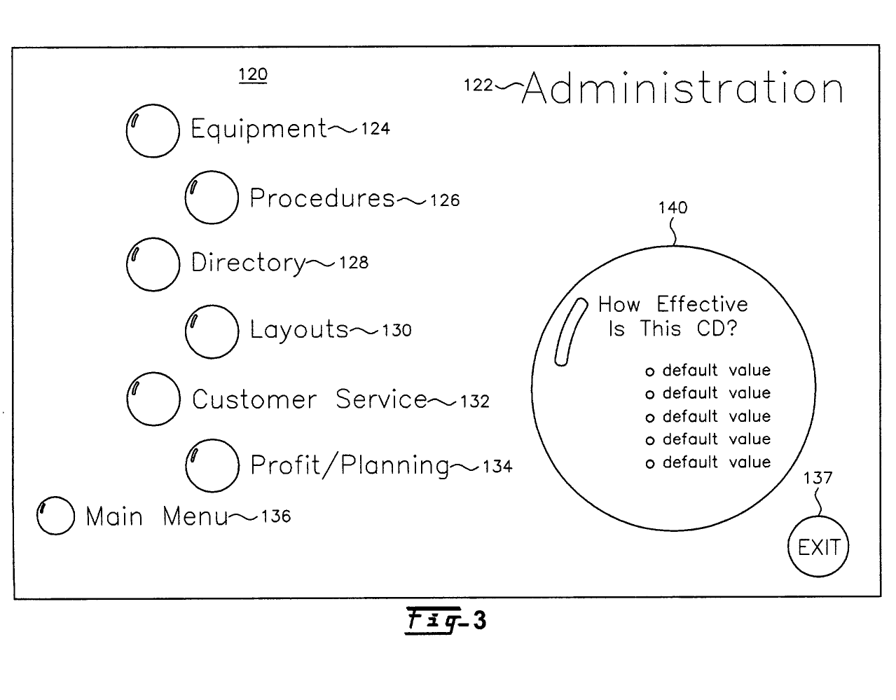

Referring now to FIG. 3, there shown is an example of a marketing software graphical user interface with a survey system. The particular example shown is an administration page 120 that is part of the administration module 16. Displayed on the page are a title or other indicia 122, and hot areas linking to the plurality of lower level administration modules. The hot areas may advantageously include equipment 124, procedures 126, directory 128, layout 130, customer service 132, and profit planning 134. Also included is an electronic survey 140. In one example embodiment, activating a main menu button 136 returns the user to the main menu page. Activating an exit button 137 exits the program.

In operation the administration hot areas are activated individually when clicked upon by a user. The equipment hot area 124 may be linked to a series of equipment displays and/or dynamic layouts with hot areas, a plurality of electronic sheets, and a plurality of electronic vignettes. Dynamic layouts may include pre-recorded audio instructions that are activated by clicking or passing a cursor over selected hot areas. Electronic vignettes may include digital animation sequences or embedded video recordings as desired.

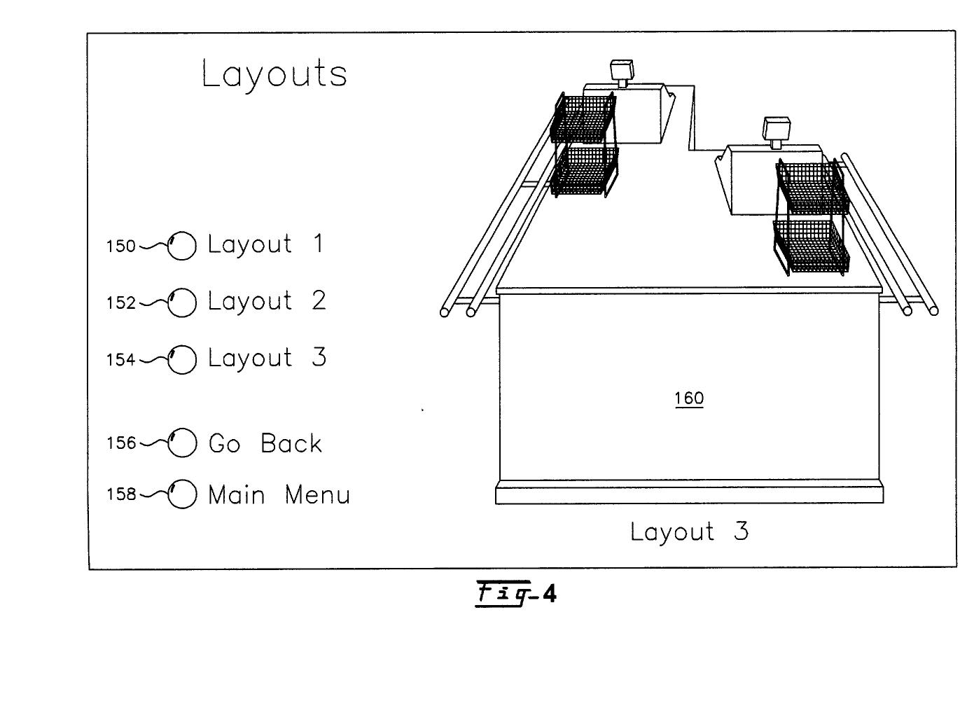

The directory 128 may be advantageously linked to a page including, for example, web sites and e-mail addresses. The layout hot area 130 may be advantageously linked to a page or series of pages including, for example, station layouts such as shown in FIG. 4. The station layouts may also have hot areas for dynamically displaying alternative variations of displaying sample signage and equipment layouts.

Now referring to FIG. 4, there schematically shown is an example embodiment of a dynamic layout with hot areas constructed in accordance with the principles of the present invention. The dynamic layout is generated by dynamic layout module 48. In one useful embodiment, the dynamic layout includes hot areas for differing layout scenarios Layout 1 (150), Layout 2 (152), and Layout 3 (154). Other hot areas include go back button 156 and main menu button 158. Activating the Layout hot areas 150-154 cause various different displays to appear on a station image 160 for the purpose of training a user on how to display merchandise, for example. The dynamic display may include animation, audio and videos as well as animation. Activating the main menu button 158 returns the user to the main menu page. Activating the go back button 158 returns the user to the previously displayed page.

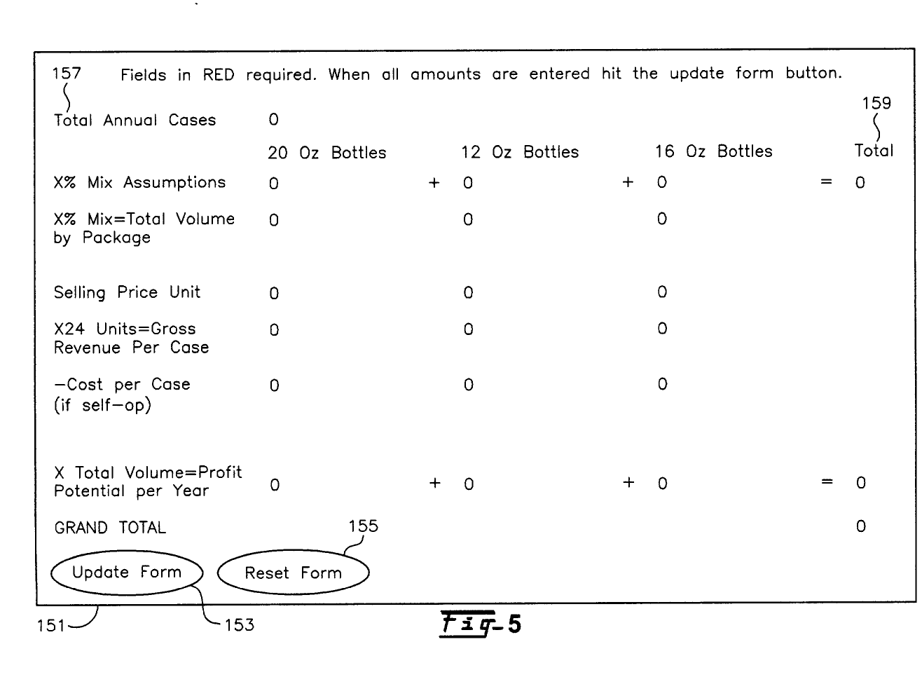

Now referring to FIG. 5, there schematically shown is an example of an electronic profit planning worksheet 151 as contemplated by one embodiment of the present invention. The profit planning worksheet may be accessed through profit planning module 52 and, for example, includes a plurality of fields arranged, for example, in columns and rows. The user may enter information such as quantity for various sized products. Moving a cursor over some fields, such as field 157 titled “Total Annual Cases,” may preferably activate audio instructions related to the field activated. Other control buttons may be included such as an update form button 153 and a reset form button 155. The electronic worksheet is linked to a calculation module that calculates mathematical formulas upon activation of the update form button 153. For example, as the user enters various quantities, percentages and costs the totals are calculated and displayed in the Total column 159. Similarly profits are calculated and displayed. Those skilled in the art having the benefit of this disclosure will understand that various other electronic worksheets may be constructed as desired for various applications.

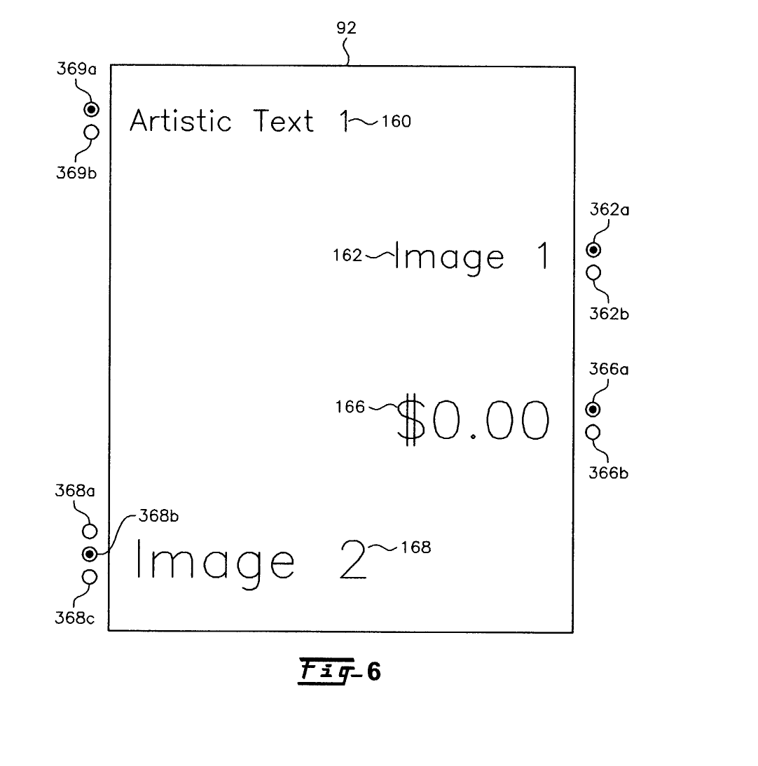

Now referring to FIG. 6 there shown schematically is an example of a second electronic marketing display sheet as contemplated by one embodiment of the invention. The second electronic marketing display sheet 92 may include artistic text 1 (160), an image 1 (162), an image 2 (168), and a price 166. An electronic marketing display sheet may be accessed through the marketing module 80. The first electronic display sheet 30 may be similarly constructed. The artistic text 1 may be dynamically changed through user activation of one of buttons 369a, 369b that are linked to a program for changing the text. Similarly, Image 1 may be dynamically changed to another image by activation of one of the associated buttons 362a, 362b, and image 2 may be dynamically changed by activation of its associated buttons 368a, 368b and 368c. The price 166 may be dynamically changed or updated by activation of price control buttons 366a and 366b.

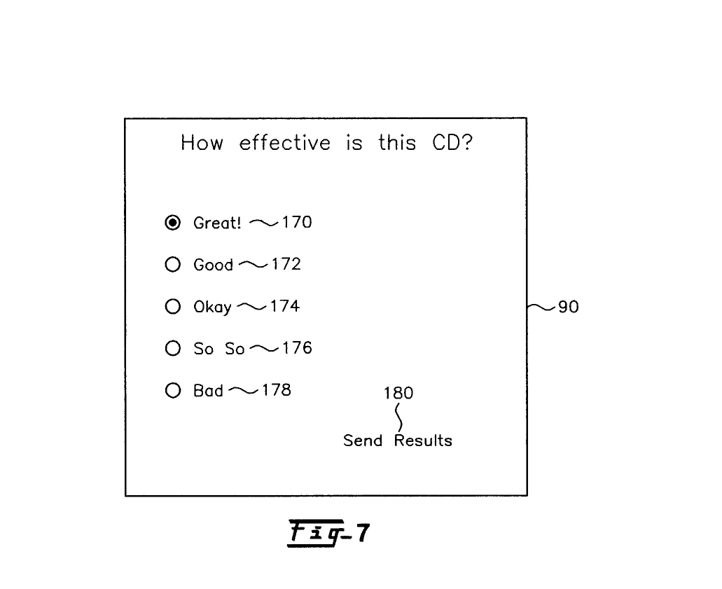

Now referring to FIG. 7, there shown is an example of an electronic survey 90 as contemplated by one example embodiment of the present invention. The electronic survey 90 may be accessed through the communications module 82 of the marketing module 80. One form of a survey, shown for illustrative purposes only, may be a satisfaction type survey having hot areas 170, 172, 174, 176 and 178 wherein one may be selected by a user clicking the user's choice. A send results hot area 180, when activated, starts an e-mail program and automatically sends the results of the survey to a predetermined site or e-mail address on the Internet, an intranet or other site.

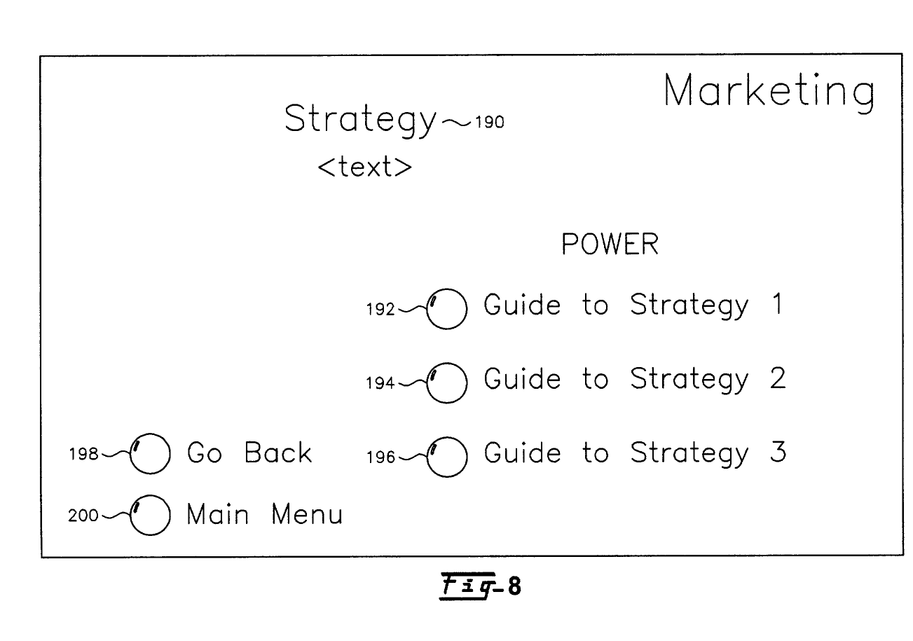

Now referring to FIG. 8, there shown is an example of an electronic vignette as contemplated by one embodiment of the present invention. The electronic vignette may include a plurality of hot areas linked to, for example, videos appropriate for various marketing strategies. The electronic vignette shown may be, for example, generated by the strategy module 86. The electronic vignette may advantageously include a heading with text 190, a plurality of strategy hot areas 192, 194 and 196, a go back button 198 and a main menu button 200. Each or any of the strategy hot areas, when activated, may let the user access further vignettes, layouts, audio and/or videos for playing on page.

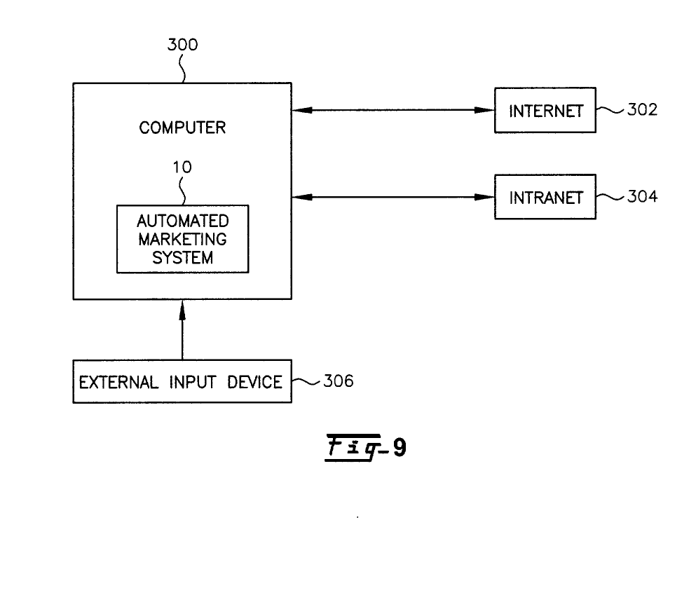

Referring now to FIG. 9, there shown is an example of computer hardware used to implement one embodiment of the present invention. The computer hardware includes a computer 300 wherein the automated marketing system 10 resides. The computer 300 may advantageously be connected to the Internet 302 or an intranet network 304. External inputs may be introduced by the user or external computer programs or devices through an external input device 306. The computer and external input device may be any known computer or computer input device, such as a keyboard or computer mouse.

Listings of exemplary code as employed in one example embodiment of the present invention are included herein as appendix A.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment and devices, and that various modifications, both as to the equipment details and operating procedures, may be accomplished without departing from the true spirit and scope of the present invention.

What is claimed is:

1. An automated marketing system for facilitate marketing of products and services comprising a graphical user interface (GUI) that accesses a computer program, the computer program and GUI access a plurality of lower level program modules, wherein the lower level program modules include at least one dynamic layout with hot areas, at least one electronic sheet, and at least one electronic vignette, and wherein the lower level program modules include computer algorithms.

2. The automated marketing process of claim 1 wherein the at least one dynamic layout comprises graphical images and sounds that change responsive to program inputs.

3. The automated marketing process of claim 2 wherein the program inputs comprise inputs selected from the group consisting of user inputs from a keyboard, user inputs from a computer mouse, software commands from external computer programs and software commands from at least one of the plurality of lower level program modules.

4. The automated marketing process of claim 1 wherein the at least one electronic sheet comprises images, sounds and numbers that change by at least one of user input, and input from the lower level program modules.

5. The automated marketing process of claim 4 wherein the program inputs comprise inputs selected from the group consisting of user inputs from a keyboard, user inputs from a computer mouse, software commands from external computer programs and software commands from at least one of the plurality of lower level program modules.

6. The automated marketing process of claim 3 wherein the at least one electronic sheet further comprises mathematical relationships for completing calculations responsive to at least one of at least one user input, and program input from the lower level program modules.

7. The automated marketing process of claim 1 wherein the at least one electronic vignette comprises graphical images and sounds that change responsive to at least one input.

8. The automated marketing process of claim 7 wherein the program inputs comprise inputs selected from the group consisting of user inputs from a keyboard, user inputs from a computer mouse, software commands from external computer programs and software commands from at least one of the plurality of lower level program modules.

9. An automated marketing system comprising:
an introduction software routine residing on a computer;
a main page software module for generating a main page display where the main page software module is linked in turn to a plurality of sub-programs including, an administration program, a human resources program and a marketing program, wherein each of the plurality of sub-programs generates a page for display including at least one of a graphical user interface, a web page, a display sheet, a survey form, a dynamic layout with hot areas and a combination of any or all of the listed pages.

10. The automated marketing system of claim 9 wherein the administration page is linked to a further plurality of administration modules including computer routines, hyperlink addresses, computer sites, Internet websites and databases.

11. The automated marketing system of claim 10 wherein the plurality of administration modules include at least one module selected from the group consisting of a planning module, a purchasing module, a distribution module, an employee module, a quality control module, an equipment module, a procedures and checklists module, a directory, at least one layout, a customer service module and a profit planning module.

12. The automated marketing system of claim 11 wherein the equipment module is linked to at least one first electronic marketing display sheet.

13. The automated marketing system of claim 11 wherein the procedures and checklists module is linked to at least one lower level module including at least one checklist and at least one procedure document.

14. The automated marketing system of claim 11 wherein the directory is linked to at least one lower level module including at least one e-mail address, and at least one corporate website site.

15. The automated marketing system of claim 11 wherein the at least one layout is linked to at least one lower level module including at least one dynamic layout area with hot areas.

16. The automated marketing system of claim 11 wherein the customer service module is linked to at least one lower level module including at least one video module.

17. The automated marketing system of claim 11 wherein the profit planning module is linked to at least one profit planning electronic marketing worksheet.

18. The automated marketing system of claim 9 wherein the human resources page is linked to a plurality of human resources page modules including computer routines, hyperlink addresses, computer sites, Internet websites and databases.

19. The automated marketing system of claim 18 wherein the plurality of human resources page modules include a training module, a hiring module and a managing module.

20. The automated marketing system of claim 19 wherein the training module includes at least one of a plurality of lower level modules selected from the group consisting of manager's tools, employee's tools and marketing tools and each of the lower level training modules optionally include at least one video.

21. The automated marketing system of claim 9 wherein the marketing page is linked to a plurality of marketing modules including computer routines, hyperlink addresses, computer sites, Internet websites and databases.

22. The automated marketing system of claim 21 wherein the plurality of marketing modules include at least one sub-program selected from the group consisting of a communications module, a promotions module and a strategy module.

23. The automated marketing system of claim 21 wherein the communications module is linked to a directory and an electronic survey.

24. The automated marketing system of claim 21 wherein the promotions module is linked to at least one electronic marketing display sheet.

25. The automated marketing system of claim 21 wherein the strategy module is linked to at least one strategy video.
